(19) United States
(12) Patent Application Publication
(10) Pub. No.: US 2007/0064936 A1
(43) Pub. Date: Mar. 22, 2007

(54) Content data delivery method and content data delivery system and handheld device for use therein

(75) Inventors: Akihiro Kasahara, Oamishirasato-machi (JP); Akira Miura, Kanagawa (JP); Hiroshi Suu, Chigasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/508,190

(22) Filed: Aug. 23, 2006

(30) Foreign Application Priority Data
Aug. 23, 2005 (JP) 2005-240616

(51) Int. Cl. H04L 9/00

(52) U.S. Cl. 380/45

(57) ABSTRACT

There is provided a content data delivery system including a playback equipment that is adapted to be able to decrypt a content data encrypted with a content key data and to play back the decrypted content data and that holds an equipment ID to identify itself; a handheld device that is adapted to be able to communicate data with the playback equipment and holds a handheld device ID to identify itself; and a server that delivers the content key data to the playback equipment via the handheld device. The server generates a first random number and transmits the first random number to the playback equipment via the handheld device. The playback equipment generates a second random number. The handheld device transmits to the server the equipment ID, handheld device ID, and second random number to provide a request for delivery of the content key data. The server and playback equipment use the first random number and second random number as a basis to generate a session key. The server uses the session key to encrypt the content key data and transmits the encrypted content key data to the playback equipment via the handheld device.

### CROSS REFERENCE TO RELATED APPLICATIONS

This application is based on and claims the benefit of priority from prior Japanese Patent Application No. 2005-240616, filed on Aug. 23, 2005, the entire contents of which are incorporated herein by reference.

### BACKGROUND OF THE INVENTION

1. Field of the Invention

The present invention relates to a content data delivery method and a content data delivery system and a handheld device for use therein.

2. Description of the Related Art

With the recent development of the information society, a content delivery system has become commonly used that delivers to a user terminal electronic contents such as electronic books, newspapers, music, and motion pictures and the like and makes the contents available to the user.

The electronic content (hereinafter referred to simply as “content”) is easily duplicatable so that illegal activities disregarding the copyright may easily occur. From a point of view of protecting the content from such illegal activities, the content is usually encrypted with an encrypted key before being recorded, and decrypted before being played back. This kind of content protection technologies include Content Protection for Prerecorded Media (CPRM), which uses a standardized encrypted key scheme such as the SD-Audio, SD-video, and SD-ePublish. This encrypted key scheme is an encrypted single key scheme in which the title key is singly encrypted with a media-specific key. An encrypted double key scheme has been proposed in which the content key is doubly encrypted with a user key and the media-specific key. This kind of encrypted double key scheme is used, for example, in the MQbic (registered trademark).

The content delivery system using such encryption schemes may be effectively used in equipment such as the mobile phone terminal or personal computer that can directly access the data delivery server, as well as in playback equipment such as the DVD player that has no such communication function. For such playback equipment to receive the content data sent from the content delivery system the content data needs to be transferred to the playback equipment via the mobile phone terminal or personal computer that has the communication function. The content data transfer with simplified operations may provide a more convenient system for the user.

### SUMMARY OF THE INVENTION

A content data delivery method according to an aspect of this invention is a content data delivery method for delivering a content data in a content data delivery system, the content data delivery system including: a playback equipment that is adapted to be able to decrypt a content data encrypted with a content key data and play back the decrypted data, and that holds an equipment ID to identify itself; a handheld device that is adapted to be able to communicate data with the playback equipment and holds a handheld device ID to identify itself; and a server that delivers the content key data to the playback equipment via the handheld device; the method comprising the steps of: allowing the server to generate a first random number and transmitting the first random number to the playback equipment via the handheld device; allowing the playback equipment to generate a second a random number; allowing the handheld device to transmit to the server the equipment ID, the handheld device ID, and the second random number and provide a request for delivery of the content key data; allowing the server and the playback equipment to use the first random number and the second random number as a basis to generate a session key; and allowing the server to use the session key to encrypt the content key data and to transmit the encrypted content key data to the playback equipment via the handheld device.

A content data delivery system according to an aspect of this invention is a content data delivery system comprising: a playback equipment that is adapted to be able to hold a content data encrypted with a content key data and, as appropriate, to acquire the content key data to decrypt and play back the content data and that holds an equipment ID to identify itself; a handheld device that is adapted to be able to communicate data with the playback equipment and holds a handheld device ID to identify itself; and a server that delivers the content key data to the playback equipment via the handheld device, the server comprising: an equipment ID transmission portion that transmits, in response to a request from the handheld device, an equipment ID to identify the playback equipment to the playback equipment via the handheld device; a database that relates and stores the equipment ID provided to the playback equipment and the handheld device ID to identify the handheld device; a transmission portion that transmits, in response to a request from the handheld device for delivery of the content key data, which request involves indication of the equipment ID and the handheld device ID, the content key data to the handheld device; and a random number generation portion that generates a first random number, wherein the playback equipment comprises a random number generation portion that generates a second random number, and the server and the playback equipment are adapted to transmit and receive the first and second random numbers and use the random numbers to generate a session key used to transmit and receive the equipment ID and content key data.

A handheld device according to an aspect of this invention is a handheld device used in a content data delivery system, the content data delivery system including: a playback equipment that is adapted to be able to decrypt and play back a content data encrypted with a content key data and holds an equipment ID to identify itself; a handheld device that is adapted to be able to communicate data with the playback equipment and holds a handheld device ID to identify itself; and a server that delivers the content key data to the playback equipment via the handheld device, the handheld device comprising: a portion that receives from the server a first random number and transmits the first random number to the playback equipment; a portion that receives from the playback equipment a second random number; a portion that transmits to the server the equipment ID, the handheld device ID, and the second random number and provides a request for delivery of the content key data; and a portion that receives the content key data encrypted with a session key generated by the server based on the first random number and second random number, and transfers the content key data to the playback equipment.

### BRIEF DESCRIPTION OF THE DRAWINGS

FIG. 1 is a schematic diagram of the configuration of a content data delivery system of the first embodiment of the present invention.

FIG. 2 is a flowchart of an example of the procedure for the initial registration operation for the DVD player 70 in the system in FIG. 1.

FIG. 3 is a screen display example of the TV receiver 80 and handheld device 60 in the initial registration operation in FIG. 2.

FIG. 4 is a flowchart illustrating an example of the procedure for purchasing the content key data Kc after the user key data Ku and equipment ID are acquired.

FIG. 5 is a screen display example of the TV receiver 80 and handheld device 60 in the procedure for purchase in FIG. 4.

FIG. 6 is a screen display example of the handheld device 60 in the procedure for purchase in FIG. 4.

FIG. 7 is a screen display example of the TV receiver 80 and handheld device 60 In the procedure for purchase in FIG. 4.

FIG. 8 is a schematic diagram of the configuration of the SD card and user terminal that correspond to the encrypted double key scheme used in the MQbic (registered trademark).

### DETAILED DESCRIPTION OF THE EMBODIMENTS

The embodiments of the present invention will now be described in detail with reference to the accompanying drawings.

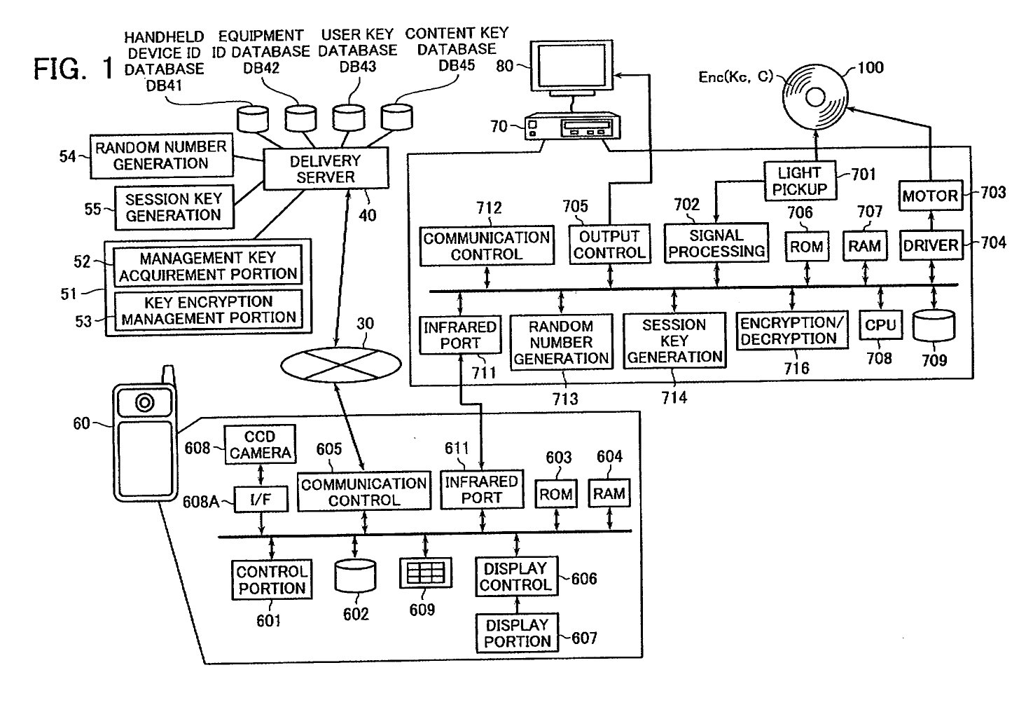

FIG. 1 is a schematic diagram of the configuration of a content data delivery system of the first embodiment of the present invention.

The content data delivery system of this embodiment is adapted to allow for communication between a delivery server 40 that delivers a content key data Kc or the like and a handheld device 60 via a network 30 including the mobile phone network, internet, or combination thereof. The handheld device 60 is adapted to be communicatable via, for example, infrared communication or the like, with a DVD player 70 owned by the user of the handheld device 60. The DVD player 70 is to play the DVD disc and is adapted to be able to output the playback data such as voice, on a TV receiver. The DVD disc 100 only records a content data Enc(Kc:C) encrypted with the content key data Kc. For playback of the content data C, it is necessary to purchase the content key data Kc from the delivery server 40. Note that the expression Enc(A:B) means herein a data B encrypted with a data A.

When the user wishes to play back the encrypted content data Enc(Kc:C) stored in the DVD player 70, the user uses the handheld device 60 to transmit to the delivery server 40 a request for delivery of the content key data Kc. The content key data Kc is thus transmitted from the delivery server 40 to the handheld device 60. The handheld device 60, after receiving the content key data Kc, uses the infrared communication function to transfer the content key data Kc to the DVD player 70 where the content key data Kc is to be stored. Note that in this embodiment, an initial registration operation performed before the request for delivery of the content key data Kc provides from the delivery server 40 via the handheld device 60 to the DVD player 70 an equipment ID to identify the DVD player 70 and a user key data Ku used to encrypt the content key data Kc. The user key data Ku and equipment ID may not be transmitted online but may be provided in advance during manufacture or at sale or the like.

The delivery server 40 has a function of receiving from the handheld device 60 the request for delivery of the content key data Kc or the like and delivering the requested content key data Kc or the like via the network 30 to the handheld device 60.

The delivery server 40 includes a handheld device ID database 41, an equipment ID database 42, a user key database 43, a content key database 45, a security module 51, a random number generation portion 54, and a session key generation portion 55.

The handheld device ID database 41 is adapted to relate and hold the data of the handheld device ID (ID60) of the handheld device 60, with reference to the equipment ID of the DVD player 70, and the user key data Kc. The equipment ID and user key data Kc are associated with the handheld device 60 in the initial registration operation or the like.

The equipment ID database 42 is adapted to hold the data of the issued equipment ID. The user key database 43 is to store the user key data Ku of the DVD player 70. The content key database 45 is adapted to hold the content key data Kc of the DVD player 70.

The security module 51 is adapted to perform the encryption/decryption processing of the user key data Ku and content key data Kc, and includes a management key acquirement portion 52 and a key encryption management portion 53. The management key acquirement portion 52 is adapted to hold a management key in such a way that the key is readable by the delivery server 40. The key encryption management portion 53 has various functions including a function of receiving the management key set by the delivery server 40, a function of using the management key as a basis to decrypt the encrypted user key data for management and encrypted content key data for management that are provided from the delivery server 40, thereby obtaining the user key data Ku and content key data Kc, and a function of encrypting the content key data Kc with the user key data Ku and transmitting the resulting encrypted content key data Enc(Ku:Kc) to the delivery server 40.

The random number generation portion 54 has a function of, when transmitting content key data or the like via the handheld device 60 to the DVD player 70, generating a random number R1 used for authentication by challenge response with the common key encryption scheme and for the generation of the session key. The session key generation portion 55 has a function of generating the session key using the random number R1 and the random numbers R2 and R3 that are generated by a random number generation portion 713 as described below.

The handheld device 60 includes a control portion 601, a memory 602, a ROM 603, a RAM 604, a communication control portion 605, a display control portion 606, a display portion 607, a CCD camera 608, an interface 608A, a keyboard 609, and an infrared port 611 and the like. The control portion 601 is to take the entire control of the handheld device 60. The memory 602 is to store an communication application program, as well as various data (such as the equipment ID) provided in the initial setting operation and the like. The ROM 603 is adapted to store a boot program that is started up on power-up or the like. The RAM 604 is adapted to temporarily store, for example, various data when the program is running.

The communication control portion 605 is to control, for example, transmitting and receiving data from the delivery server 40 and DVD player 70 and the like. The display control portion 606 is to control the execution screen for the communication application as well as other output screens on the display portion 607. The infrared port 611 is to output the various data that are converted into the infrared pulse signals by the communication control portion 605, as infrared light, to outside such as the DVD player 70.

The DVD player 70 includes a light pickup 701 that reads the signal of the DVD disc 100, a signal processing portion 702 that processes the output signal of the light pickup 701, a spindle motor 703 that rotates the DVD disc, a driver 704 that drives the spindle motor 703, an output control portion 705, a ROM 706, a RAM 707, and a CPU 708 and the like. Because these components correspond to the normal configuration of the DVD player 70, their detailed description is omitted here. The DVD player 70 also includes a memory 709 that stores the above-described equipment ID (170), user key data Kc, and content key data Kc and the like. Note that in this embodiment, the memory 709 includes a key management software.

The DVD player 70 also includes an signal processing 711 that performs infrared communication with the handheld device 60. A communication control portion 712 is to analyze the infrared pulse signal received by the infrared port 711 and to perform an predetermined control of the signal.

The DVD player 70 also includes, as a means for outputting a signal to outside, a random number generation portion 713, a session key generation portion 714, and an encryption/decryption portion 716. The random number generation portion 713 is adapted to generate the random numbers R2 and R3 used for authentication by challenge response with the common key encryption scheme and for the generation of the session key. The session key generation portion 714 has a function of generating the session key using the above-described random number R1 and the random numbers R2 and R3. Secure communication is thus possible between the DVD player 70 and delivery server 40 via the handheld device 60. The encryption/decryption portion 716 has a function of encrypting the random numbers R2 and R3 and other information according to a predetermined protocol and decrypting the encrypted data sent from the handheld device 60.

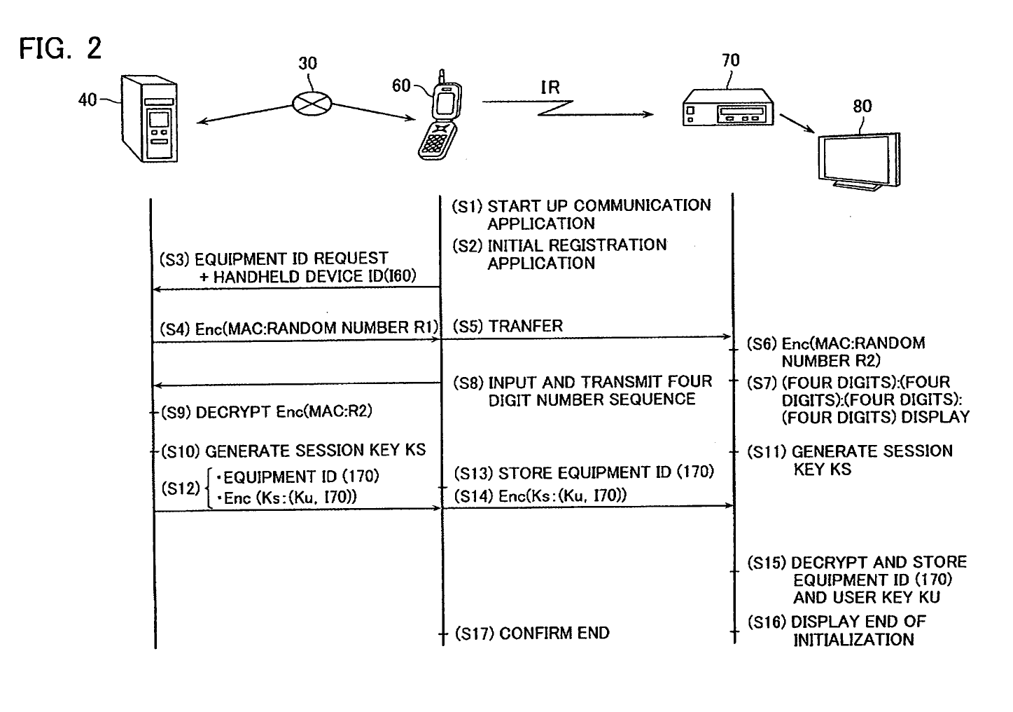

With reference to FIGS. 2 to 7, a description is given below of the operation procedure of the content data delivery system. The content data delivery system first performs the initial registration operation where the equipment data of DVD player 70 and the user key data Ku are delivered from the delivery server 40. Following the initial registration operation is a key purchase operation that purchases the content key data Kc from the delivery server 40 and stores the data in the DVD player 70.

With reference to FIG. 2, an example of the operation procedure of the initial registration operation is first described. To start the initial registration operation, the user starts up the communication application stored in the handheld device 60 (S1). The user then selects from the application menu application of the initial registration operation (S2). The user then indicates the handheld device ID (I60) and requests assignment of the equipment ID to the user's own DVD player 70 (S3). The delivery server 40 generates the random number R1 used for the authentication by challenge response with the common key encryption scheme and for the generation of the session key and then encrypts the random number R1 with the MAC key to produce a data Enc(MAC:R1), which is transmitted to the handheld device 60 (S4).

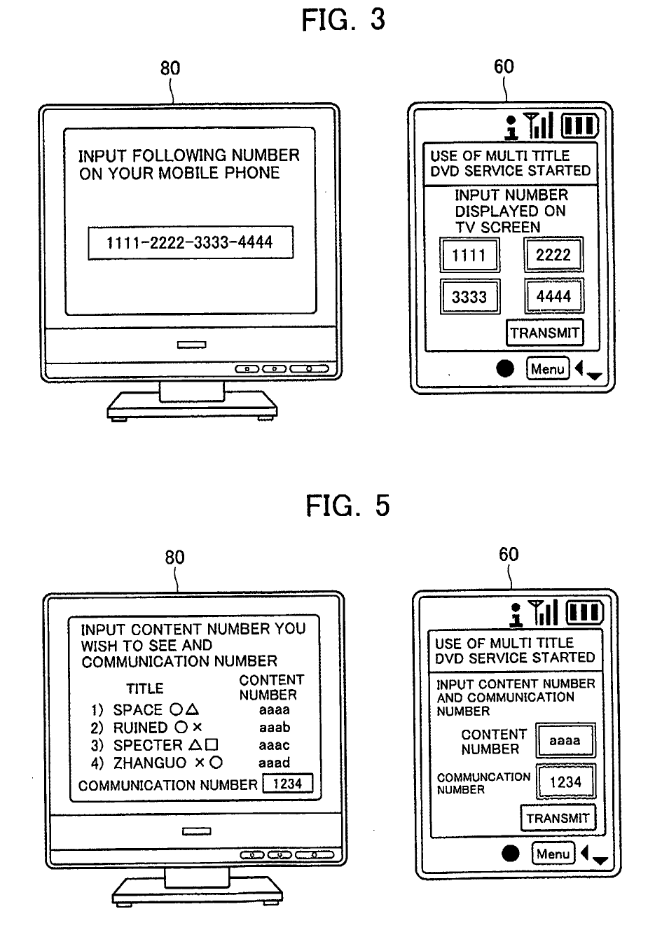

The handheld device 60 transfers the data Enc(MAC:R1) from the infrared port 611 to the DVD player 70 (S5). The DVD player 70 uses the MAC key to decrypt the random number R1 and stores the decrypted R1 in the memory 709 and then generates the random number R2 different from the random number R1 in the random number generation portion 713 (S6). The DVD player 70 then encrypts the random number R2 with the MAC key to produce a data Enc(MAC:R2), and converts according to a predetermined protocol, the data Enc(MAC:R2) into a number sequence of 16 characters of four digits by four sets, and displays the number sequence on the TV receiver 80 as shown in FIG. 3 (S7). Note that the number sequence may be replaced by characters of more numbers, such as the hiragana characters, katakana characters, kanji characters, and alphabets, thereby making it possible to express the random number R2 with less characters. Because the mobile phone or the like relies on the hiragana character input, a hiragana character sequence may eliminate the conversion operation of the input mode and decrease the number of input characters, thereby providing convenience to the user.

The user sees the display on the TV receiver 80, and inputs the displayed number sequence of four digits by four sets from the keyboard 609 of the handheld device 60 as shown in FIG. 3, and presses the “TRANSMIT” button to transmit the number sequence to the delivery server 40 (S8). The delivery server 40 receives the number sequence of four digits by four sets and reverse-converts the number sequence according to the above-described protocol to produce the encrypted data Enc(MAC:R2). The delivery server 40 further decrypts the encrypted data with the MAC key to produce the random number R2 (S9). The delivery server 40 and DVD recorder 70 use the resulting random numbers R1 and R2 thus obtained and the confidential information K1 and K2 of the common key cipher scheme to generate the session key Ks (S10 and S11). The delivery server 40 then transmits to the handheld device 60 (S12) the data of the equipment ID (I70) and the dataEnc(Ks:(Ku, I70)) that is obtained by encrypting the user key Ku and equipment ID (I70) with the session key Ks (S12). The handheld device 60 stores the equipment ID (I70) in its own memory 602 (S13), and transfers the encrypted data Enc(Ks:(Ku,I70)) to the DVD 70 from the infrared port 611 (S14). The DVD player 70 uses the MAC key to decrypt the data of the equipment ID (I70) and the user key data Ku, and stores the decrypted data in the memory 709 (S15). The initial registration operation is then ended. The end of the initial registration operation is displayed on the TV receiver 80 (S16), which is confirmed by the user (S17). The end of the initial registration operation may thus be confirmed.

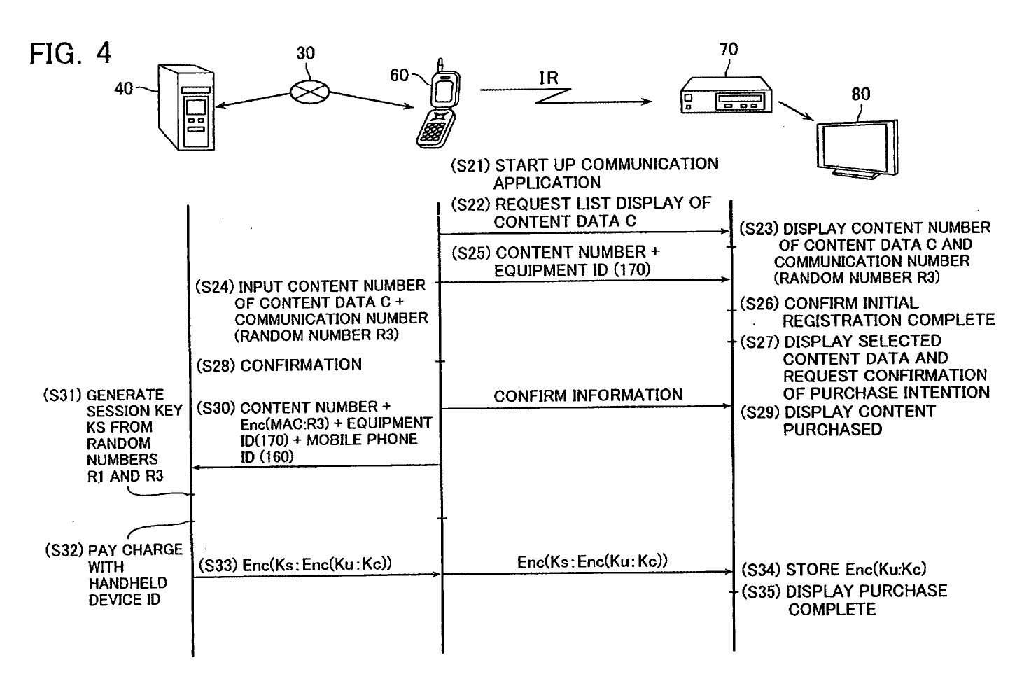

Referring now to FIG. 4, a description is given of an example of the operation procedure for purchasing the content key data Kc after the user key data Ku and equipment ID (I70) are acquired. The user starts up the communication application stored in the handheld device 60 (S21), and then uses the application to request the DVD player 70 to display the list of the encrypted content data C stored in the DVD disc 100 (S22). This request is transmitted via the infrared port 611. After receiving the request. the DVD player 70 reads the DVD disc 100, and displays on the TV receiver 80, as shown in FIG. 5, the list of the content number (a number sequence of about four digits) of the stored content data C or the title of the content data C or the like together with the random number R3 displayed as “COMMUNICATION NUMBER” (FIG. 5 shows an example of R3=1234)(S23). The random number R3 is generated in the random number generation portion 713 each time the handheld device 60 provides a request for display of the list of the content data C and is different from the random number R2.

The user sees the list and inputs from the keyboard 609 the four-digit content number of the content data C that the user wishes to play back and the random number R3 as the communication number, and confirms the correct input on the screen, and then presses the “TRANSMIT” button for transmission (S24). The content number together with the data of the equipment ID (I70) are transmitted from the handheld device 60 to the DVD player 70 via the infrared port 611 (S25). The DVD player 70 confirms the content number and also confirms whether the data of the equipment ID sent from the handheld device 60 coincides with the equipment ID (I70) stored in the DVD player 70. If so, then the DVD player 70 confirms that the initial registration is complete in the delivery server 40 (S26), and then displays the content data C of the selected content number on the TV receiver 80 and requests the user to confirm his/her purchase intention (S27). The user operates the keyboard 609 of the handheld device 60 to transmit a signal indicating the purchase intention to the DVD player 70 and delivery server 40. The TV receiver 80 then displays a message indicating that the content is purchased (S29). The signal indicating the purchase intention transmitted to the delivery server 40 includes the content number, equipment ID (I70), handheld device ID (I60), as well as the random number R3 (encrypted with the MAC key) displayed as the communication number (S30). After receiving the random number R3. the delivery server 40 uses the random number R1 used in the initial registration operation and the random number R3 to generate the session key Ks (S31). The DVD player 70, which also has the data of the random numbers R1 and R3, also generates the session key Ks.

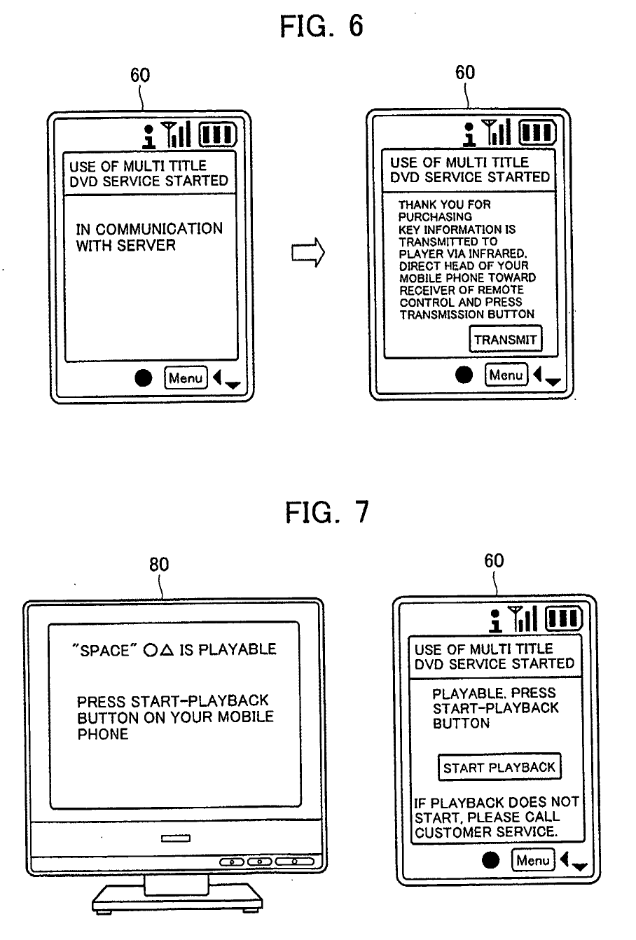

The delivery server 40 confirms whether the data of the combination of the transmitted equipment ID (I70) and handheld device ID (I60) exists in the handheld device ID database 41. If so, then the delivery server 40 uses the handheld device ID (I60) as a basis to pay the charge for the content number (S32). The delivery server 40 then encrypts the content ID corresponding to the content number and the content key data Kc corresponding to the selected content data with the user key Ku and encrypts again the encrypted data with the session key Ks to produce a data Enc(Ks:Enc(Ku:Kc)), which is transmitted from the delivery server 40 to the handheld device 60. During transmission, as shown in the left of FIG. 6. the handheld device 60 displays “IN COMMUNICATION WITH SERVER” on its screen. When receiving is complete, as shown in the right of the FIG. 6, a message is displayed requesting the user to direct the head of the mobile phone, i.e., the infrared port 611, toward the infrared port 711 of the DVD player 70 and to press the transmission button. Pressing the transmission button transmits the Enc(Ks:Enc(Ku:Kc)) to the DVD player 70. The DVD player 70 receives the Enc(Ks:Enc(Ku:Kc)) and encrypts it with the generated session key Ks to produce the encrypted data Enc(Ku:Kc), which is then stored in the memory 709 (S34). The procedure for purchasing the content key data Kc is then ended (S35). Referring to FIG. 7, the screens of the TV receiver 80 and handheld device 60 display messages indicating that the content is playable. The user key data Ku is used to decrypt the encrypted data Enc(Ku:Kc) stored in the memory 709 to provide the content key data Kc. The content key data Kc is then used to decrypt the content data C stored in the DVD disc 100 to make it possible to play back the content data C.

This embodiment provides a procedure for purchasing the content key data Kc where the content key data Kc is encrypted with the user key Ku to produce the Enc(Ku:Kc). The Enc(Ku:Kc) is encrypted again with the session key Ks to produce the Enc(Ks:Enc(Ku:Kc)). The session key Ks is generated using the random number R3 newly generated in the procedure for purchasing, and the Enc(Ks:Enc(Ku:Kc)) is then transmitted to the DVD player 70. Different random numbers R3 are used for each request for delivery of the content key data Kc to produce different session keys Ks because when the content key data Kc is for rental for a specified period, for example, the following illegal activities need to be prevented. The same session key Ks for each request for delivery of the content key data Kc would allow the user to copy the data Enc(Ks:Enc(Ku:Kc)) included in the infrared communication signal to the so-called learning remote control or the like, for example, and to use, after the specified period (rental period) expired, the learning remote control or the like to use the content data illegally. To allow for the appropriate management of the rental service, it is effective to use the new random number R3 for each request to generate the new session key as described above.

Note that the present invention is not limited to the embodiments described above and modified components may be implemented without departing from the spirit of the present invention. The plurality of components disclosed in the embodiments described above may be appropriately combined to form various embodiments of the invention. For example, some of the components disclosed in the above embodiments may be deleted. Further, different components of the different embodiments may be appropriately combined.

Although, for example, the above embodiments illustrate the DVD player 70 as an example of the playback equipment, any device may be applied with the present invention that has a function of decrypting and playing back the encrypted content data, such as the hard disk recorder/player or personal computer. Although the above embodiments perform the communication between the DVD player 70 and handheld device 60 using infrared communication via the infrared ports 611 and 711, other data communication using another interface such as the USB or IEEE1394 may be used.

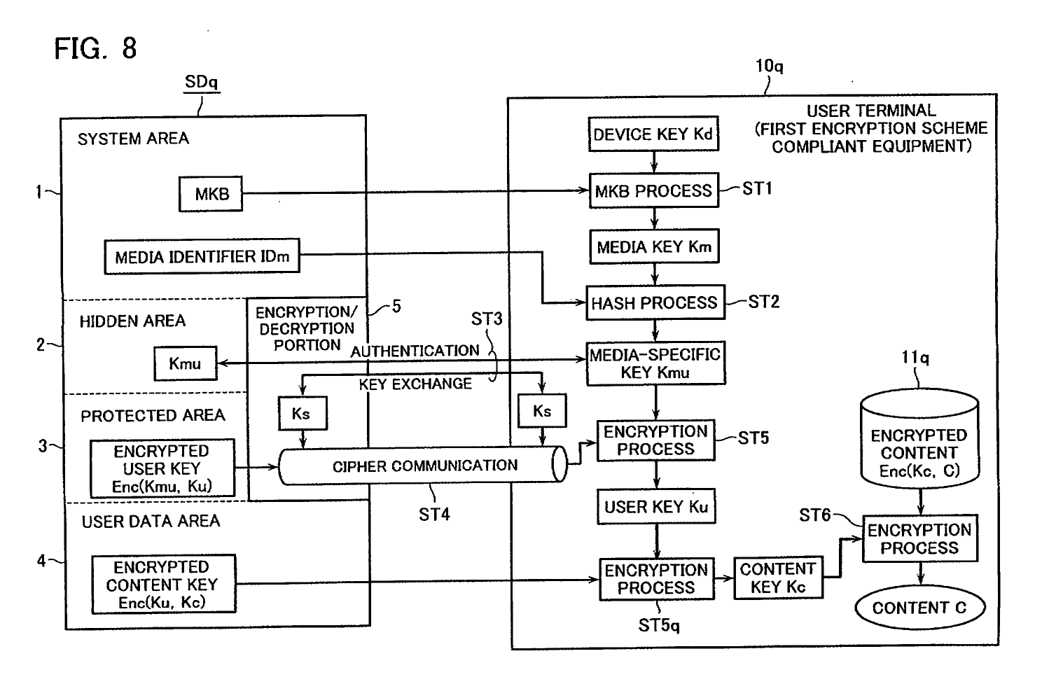

In the above embodiments, for example, the encrypted double key scheme used in the MQbic (registered trademark) may be applied, and the SD card corresponding to the MQbic may store the above described user key data Ku and content key data Kc. FIG. 8 is a schematic diagram of the configuration of the SD card and user terminal corresponding to the encrypted double key scheme used in the MQbic. The SD card SDq is an example of the secure storage media that securely stores the data. The SD memory card SDq includes a system area 1, a hidden area 2, a protected area 3, a user data area 4, and an encryption/decryption portion 5. Each of the areas 1 to 4 stores a data.

Specifically, in the SD memory card SDq, the system area 1 stores a key management information media key block (MKB) and a media identifier IDm, the hidden area 2 stores a media-specific key data Kmu, the protected area 3 stores an encrypted user key data Enc(Kmu:Ku), and the user data area 4 stores a content key data Enc(Ku:Kc). The user key Ku is used in common for a plurality of encrypted content keys Enc (Ku:Kc), Enc(Ku:Kc2) . . . The subscript q of the SD card SDq indicates that the SD card SDq corresponds to the MObic (registered trademark).

The system area 1 is read-only and accessible from outside of the SD memory card . The hidden area 2 is also read-only and is referred by the SD memory card itself and is never accessible from outside of the SD memory card. The protected area 3 may be read/written from outside of the SD memory card if the user is successfully authenticated. The user data area 4 may be freely read/written from outside of the SD memory card. The encryption/decryption portion 5 is adapted to perform the authentication, key exchange, and cipher communication between the protected area 3 and outside of the SD memory card, and has a function of encryption/decryption.

For such a SD card SDq, the user terminal 10q for playback operates logically as follows. The user terminal 10q performs, using a preset device key Kd, an MKB process (ST1) on the key management information MKB read from the system area 1 of the SD card SDq, thereby obtaining a media key Km. The user terminal 10q then performs a hash process (ST2) both on the media key Km and on the media identifier IDm that is read from the system area 1 of the SD card SDq, thereby obtaining a media-specific key Kmu.

The user terminal 10q then uses the media-specific key Kmu as a basis to perform the authentication and key exchange (AKE) (ST3) with the encryption/decryption portion 5 of the SD card SDq, thereby sharing the session key Ks with the SD card SDq. Note that the authentication and key exchange at step 3 are successful thereby sharing the session key Ks when the media-specific key Kmu in the hidden area 2 that is referred to by the encryption/decryption portion 5 coincides with the media-specific key Kmu generated in the handheld device 10a.

The user terminal 10q then reads, via the cipher communication using the session key Ks (ST4), the encrypted user key Enc (Kmu:Ku) from the protected area 23 , and decrypts (ST5) the encrypted user key Enc (Kmu:Ku) with the media-specific key Kmu, thereby obtaining the user key Ku.

Finally, the user terminal 10q reads the encrypted content key Enc(Ku:Kc) from the user data area 4 of the SD card SDq, and then decrypts (ST5q) the encrypted content key Enc(Ku:Kc) with the user key Ku, thereby obtaining the content key Kc. Finally, the user terminal 10q reads the encrypted content Enc (Kc:C) from the memory 11q, and then decrypts (ST6) the encrypted content Enc (Kc:C) with the content key Kc and plays back the resulting content C. Note that although in the above example the encrypted content is stored in the memory 11q in the user terminal 10q , the encrypted content may be stored in an external storage media.

The encrypted double key scheme described above holds the encrypted content key in the user data area 4 having a larger storage capacity than the protection area 3, so that the encrypted double key scheme may store a larger amount of encrypted content key than the encrypted single key scheme. The encrypted double key scheme may also hold the encrypted content in outside of the SD card, so that the encrypted double key scheme is expected to facilitate the distribution of the encrypted content.

The encrypted double key scheme also provides each SD card with the media identifier as the identifier and issues the specific user key (media specific key) for each media identifier. The media-specific key is used to encrypt the user key, which is then stored in the protected area of the SD card. The encryption of the user key depends on the media identifier, and a valid player may only decrypt the encrypted user key. An intruder that illegally copies only the content key from the user data area may thus not acquire the content. Even when such a user terminal is used as the playback equipment and the handheld device provides the content key data or the like to the user terminal, the present invention is applicable.

What is claimed is:

1. A content data delivery method for delivering a content data in a content data delivery system, said content data delivery system including:
a playback equipment that is adapted to be able to decrypt a content data encrypted with a content key data and play back the decrypted data, and that holds an equipment ID to identify itself;
a handheld device that is adapted to be able to communicate data with the playback equipment and holds a handheld device ID to identify itself; and
a server that delivers said content key data to said playback equipment via said handheld device,
said method comprising the steps of:
allowing said server to generate a first random number and transmitting the first random number to said playback equipment via said handheld device;
allowing said playback equipment to generate a second random number;
allowing said handheld device to transmit to said server said equipment ID, said handheld device ID, and said second random number and provide a request for delivery of said content key data;
allowing said server and said playback equipment to use said first random number and said second random number as a basis to generate a session key; and
allowing said server to use said session key to encrypt said content key data and to transmit the encrypted content key data to said playback equipment via said handheld device.

2. The content data delivery method of claim 1, wherein
said second random number is made to be a different random number each time a request for delivery of different said content data is provided.

3. The content data delivery method of claim 1, wherein
said first random number is issued in initial registration performed before said content data delivery.

4. A content data delivery system comprising:
a playback equipment that is adapted to be able to hold a content data encrypted with a content key data, to acquire said content key data to decrypt and play back said content data, and to hold an equipment ID to identify itself;
a handheld device that is adapted to be able to communicate data with the playback equipment and holds a handheld device ID to identify itself; and
a server that delivers said content key data to said playback equipment via said handheld device,
said server comprising:
an equipment ID transmission portion that transmits, in response to a request from said handheld device, an equipment ID to identify said playback equipment to said playback equipment via said handheld device:
a database that relates and stores said equipment ID provided to the playback equipment and said handheld device ID to identify the handheld device;
a transmission portion that transmits said content key data to said handheld device, in response to a request from said handheld device for delivery of the content key data, the request involving indication of said equipment ID and said handheld device ID; and
a random number generation portion that generates a first random number,
wherein
said playback equipment comprises a random number generation portion that generates a second random number, and said server and said playback equipment are adapted to transmit and receive said first and second random numbers and use the random numbers to generate a session key used to transmit and receive said equipment ID and content key data.

5. The content data delivery system of claim 4, wherein
said second random number is made to be a different random number each time a request for delivery of different said content data is provided.

6. The content data delivery system of claim 5, wherein
said first random number is issued in initial registration performed before said content data delivery.

7. A handheld device capable to communicate with a server that delivers a content key data to encrypt an encrypted content data, and communicate with a playback equipment to decrypt and play back the encrypted content data with the content key data, comprising:
a memory to store a handheld device ID;
a first means for receiving a first random number from the server and transmits the first random number to the playback equipment;
a second means for receiving a second random number from the playback equipment;
a third means for transmitting a request for delivery of the content key data to the server, accompanied by an equipment ID being assigned to the playback equipment, the handheld device ID, and the second random number;
a fourth means for receiving the content key data encrypted with a session key generated by the server based on the first random number and the second random number; and
a fifth means for transferring the content key data encrypted with the session key, to the playback equipment.
